(19) United States
(12) Patent Application Publication
(10) Pub. No.: US 2018/0300763 A1
(43) Pub. Date: Oct. 18, 2018

(54) NON-PROFIT FUNDING CAMPAIGN MANAGEMENT EMPLOYING A PREDICTIVE ANALYTICS INTELLIGENCE PLATFORM

(71) Applicant: Campaign Partners, Inc., Reston, VA (US)

(72) Inventors: Francis Q. Hoang, Alexandria, VA (US); Eric James Okimoto, Winter Garden, FL (US); Jason Crabtree, Vienna, VA (US); Andrew Sellers, Colorado Springs, CO (US); Shawn Nathan Olds, Dumfries, VA (US); Bridget Parke, Vienna, VA (US)

(21) Appl. No.: 15/486,249

(22) Filed: Apr. 12, 2017

(51) Int. Cl. G06Q 30/02; G06Q 50/00; G06F 17/30

(52) U.S. Cl. CPC G06Q 30/0269; G06Q 50/01; G06F 17/30864; G06Q 30/0209; G06Q 30/0279

(57) ABSTRACT

A system for campaign management employing a high volume web search and predictive analytic capabilities has been devised. A campaign control module is used to accept commands, parameters, and data defining a fundraising campaign and use those commands to instruct operation of the system to maximize participation while maintaining the enthusiasm of participants to continue to support the cause though regular contact. Web searches retrieve participant contact, financial, and social media post information which is then predictively analyzed to maximize the impact of individualized messages sent and automatically maintain the integrity of each participant's data store record.

### CROSS-REFERENCE TO RELATED APPLICATIONS

None.

### BACKGROUND OF THE INVENTION

### Field of the Invention

The present invention is in the field of use of computer systems in prospective campaign participant contact management, operations and predictive planning. Specifically, the use of a predictive analytics intelligence system to provide ongoing new prospective contact discovery and existing participant connection maintenance for subscription member organizations.

### Discussion of the State of the Art

Campaigns involving contacts for which significant information may be known but for whom the best motivating tact for a desired action is unknown frequently arise in the areas of sales campaigns, donor sponsored funding campaigns and volunteer work. Such campaigns may be highly localized or if regional, relying heavily on the work of local representatives to identify participant prospects, collect the donations or organize participant activities and maintain contact information which, if the overall operation was centralized, was done with pencil and paper by mail which was both failure prone and time consuming. More recently, with the advent of computers and the internet much of the donor relationship management work done on computers and information such as contact information and possible income and participation level information for participants as well as progress data available for campaign agents easily available. Donor relationship management packages such as BLACKBAUD LUMINATE™, BLACKBAUD NETCOMMUNITY™, CAUSEVOX™ and DONORPERFECT™ among others have assisted in the area of charitable giving organization. Even today, however, much of the brute force work such as maintaining participant contact information, validating newly submitted participant contact information, sending an effective message to a participant or group of participants either during a campaign or between campaigns to maintain goodwill, participant enthusiasm for the cause and desire to generously give is left totally in the hands of human development workers. A new software offering, BLACKBAUD RAISER'S EDGE™ does use a small amount of automation to maintain charitable donation contact information through current address lookup and smart donation range guidelines through donor wealth guidelines but does not perform advanced predictive analytics available through modern software engineering to minimize human involvement in these tasks while maximizing productivity in higher, planning functions.

What is needed is a fully integrated system that retrieves donor contact, employment, and lifestyle information to establish correct address information and predictively estimate level of wealth, retrieve and predictively analyze social media data to predict the level of interest in, excitement for and therefore potential to contribute to a campaign and automatically translates those data points into a microtargeted participation request message visually configured and worded with a suggested action range or product range predicted to return the maximal investment from the participation prospect. The system should further use retrieved contact information to maintain participant data store integrity, automatically track campaign progress, place participants in predefined campaign categories for the sending of special incentives, certificates and messages and send all donors personalized messages tailored to maintain their enthusiasm for the non-profit and its cause to better ensure action in subsequent campaigns all though the application of deep learning and predictive analytics.

### SUMMARY OF THE INVENTION

Accordingly, the inventor has developed a system for prospective customer action anticipation employing a predictive analytics intelligence platform. In a typical embodiment, campaign defining directives are entered by the campaign director or a campaign officer setting the parameters for a campaign. A general message or theme may be defined, the length of the campaign set, bundlers set up, participants assigned and in cases of charitable fundraisers, officers responsible for specific areas such as the disposition in-kind gifts defined. Once a campaign is entered into the campaign management system, the system performs the heavy lifting by confirming the reliability of participant contact information, analytically predicting the level of monetary or action expenditure to which each participant may be amenable, using social media data points to anticipate the best message appearance wording and participation option presentation and, if part of the campaign, finding potential new participants by web search of social media postings matching one or more key-phrases or keywords. All of these tasks are carried out through the use of a high volume web crawler and deep learning predictive analytics functions specifically programmed for participant analysis. The system will also ensure that participants are automatically granted and receive any special participation incentives such as certificates, rebates or gifts for which they qualify, that high or repeat high expenditure participants are flagged to receive special offers and perks and that all participants receive some form of contact designed to keep the interest in the cause ongoing and the enthusiasm to give high. Lastly, throughout the campaign, progress reports and displays maybe examined and performance monitored, possibly rewarded or incentivized using games and competitions for getting new participants or getting indicators of active participation interest fulfilled.

According to a preferred embodiment of the invention, a system for prospective participant action anticipation employing a predictive analytics intelligence platform comprising: a campaign control module stored in a memory of and operating on a processor of a computing device and configured to: employ commands, parameters, and data completely defining a campaign from a campaign agent with campaign definition authority, use the campaign defining commands, parameters and data to control and coordinate the actions of other system modules to carry out their functions in the campaign, use campaign defining commands, parameters and data to group participants based upon pre-defined participation characteristics to enhance participant goodwill, interest and expenditure towards both during and after the campaign, maintain progress data on pre-determined facets of the campaign; and direct maintenance of donor record data store record integrity. A web search module stored in a memory of and operating on a processor of a computing device and configured to: retrieve plurality of contact information specific to campaign participants from a plurality of cloud sources both public and proprietary, retrieve social media posts specific to campaign cause from a plurality of cloud sources both public and proprietary; and retrieve participant life status information useful to personalizing the campaign message from a plurality of cloud sources both public and proprietary. A predictive analytics module stored in a memory of and operating on a processor of a computing device and configured to: use social media posts retrieved by the web search module to predict the likelihood of the participant to participate and the level of connection the donor has to a fundraising cause, use financial and life status data retrieved by the web search module to predict a monetary range likely to elicit a maximal participation level choice by the participant; use social media posts and contact information to predict the reliability of newly discovered contact address changes as part of function to maintain participant record data store record integrity. A user interface stored in a memory of and operating on a processor of a computing device and configured to: accept commands, parameters and data from commands, parameters, and data completely defining a fundraising campaign from a campaign agent with campaign definition authority, accept donor information participation pledge information and participation level information from a campaign bundler, display goal information, pledged participation level information and participation levels already achieved in formats most useful to campaign agents and predesignated by campaign agents with campaign definition authority, and receive peer-to-peer participant contact information from participants already enrolled in the campaign.

According to a preferred embodiment of the invention, method for prospective participant action anticipation employing a predictive analytics intelligence platform comprising the steps of: a) receiving a campaign plan from a campaign agent with campaign definition authority into a central control module using a user interface; b) implementing and coordinating the campaign plan throughout the system using the central control module; c) retrieving participant contact information, income and lifestyle data and social media postings from both private and proprietary sources using a web search module; d) determining reliable contact information, predictive level of interest in campaign cause, predictive participation level range or in-kind donation possibility using a predictive analytics module; e) predicting the best participation evoking message for a participant using the predictive analysis module; f) implementing a participant interest, goodwill and participation retention program using both the predictive analytics module and the central control module; g) maintaining integrity of a participant record data store using the web search module, the predictive analytics module and the central control module; h) displaying campaign progress in multiple predesignated formats using the user interface; i) receiving peer to peer participant information from enrolled participants using the user interface.

### BRIEF DESCRIPTION OF THE DRAWING FIGURES

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 is a diagram of exemplary architecture of a funding campaign and donor cultivation management system according to an embodiment of the invention.

FIG. 2 is a flow diagram of exemplary function of the funding campaign and donor cultivation management system according to an embodiment of the invention.

FIG. 3 is a flow diagram of exemplary function of the funding campaign and donor cultivation management system to insure the integrity of the permanent donor database according to an embodiment of the invention.

FIG. 4 is a block diagram illustrating an exemplary hardware architecture of a computing device used in various embodiments of the invention.

FIG. 5 is a block diagram illustrating an exemplary logical architecture for a client device, according to various embodiments of the invention.

FIG. 6 is a block diagram illustrating an exemplary architectural arrangement of clients, servers, and external services, according to various embodiments of the invention.

FIG. 7 is another block diagram illustrating an exemplary hardware architecture of a computing device used in various embodiments of the invention.

### DETAILED DESCRIPTION

The inventor has conceived, and reduced to practice, a system for prospective customer action anticipation employing a predictive analytics intelligence platform.

One or more different inventions may be described in the present application. Further, for one or more of the inventions described herein, numerous alternative embodiments may be described; it should be understood that these are presented for illustrative purposes only. The described embodiments are not intended to be limiting in any sense. One or more of the inventions may be widely applicable to numerous embodiments, as is readily apparent from the disclosure. In general, embodiments are described in sufficient detail to enable those skilled in the art to practice one or more of the inventions, and it is to be understood that other embodiments may be utilized and that structural, logical, software, electrical and other changes may be made without departing from the scope of the particular inventions. Accordingly, those skilled in the art will recognize that one or more of the inventions may be practiced with various modifications and alterations. Particular features of one or more of the inventions may be described with reference to one or more particular embodiments or figures that form a part of the present disclosure, and in which are shown, by way of illustration, specific embodiments of one or more of the inventions. It should be understood, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring sequentially (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described, it will be readily apparent that more than one device or article may be used in place of a single device or article. Similarly, where more than one device or article is described, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be noted that particular embodiments include multiple iterations of a technique or multiple manifestations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

Program functions and capabilities are not always attributed to a named software set or library. This in no instance implies that such a specific program, program function, or code library is not employed but is meant to allow time progression based changes to be made. In all cases at least one open source or proprietary software package providing the attributed functional result may be available and known to those skilled in the art or the algorithm needed to accomplish the function determinable by those skilled in the art.

### Conceptual Architecture

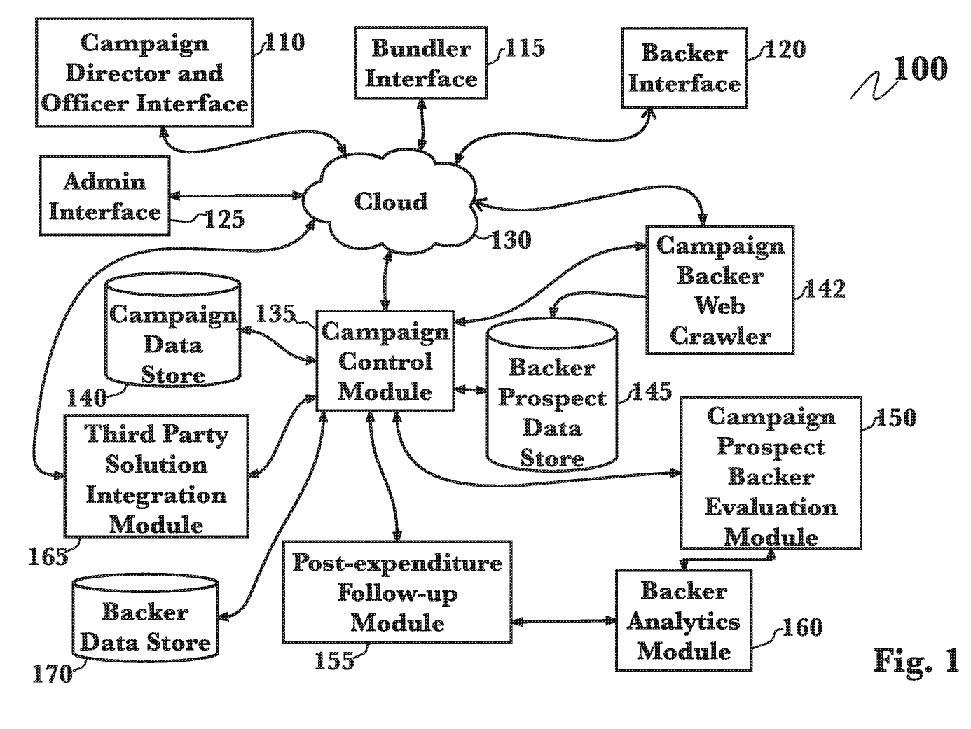

FIG. 1 is a diagram of exemplary architecture of the funding campaign and donor cultivation management cloud service system 100 according to an embodiment of the invention. Campaigns for several types of organizations from sales to charitable giving may involve multiple layers of participants. The campaign management system allows for multiple user types with easily configured, multileveled set of capabilities. In the depicted embodiment are shown an interface for the campaign director and her officers 110. This grouping, which in other embodiments might be further divided with the director having capabilities within the system that the officers do not (not depicted), may be responsible for all of the administrative set-up of one or more campaigns such as but not limited to goals, both monetary and social; beneficiary designations and groupings; themes;

specific campaign messages to be used; intended regional scope of the fundraiser; social media message key phrases from which to intelligently build participant searches; parameters with which to select backers from pools of prospects; levels of predictive social-media-post-cause matching at which new participants may be selected and contacted solely from predictive analytic identification of prospective likely backers, if at all; allowed in-kind donations; suggested participation levels presented to backer in relationship to representative recorded or cloud 130 returned participant income levels 140; participation levels at which backers enter certain high worth designations and may receive specialized responses or specific thank you gifts or rebates; backer information to be collected; desired participant relationship cultivation rules; set-up of bundlers and bundler interfaces 115; set-up of donor landing pages and participant interfaces 120; monitoring of the progress of currently running campaigns, possibly displayed in multiple formats (bar graphs, tabular by sub-region, line graph showing comparative progress of current and previous years, or other formats useful to and specified by the campaign director, ability to retrieve names of one or more grouped participants); in addition to other capabilities known to those skilled in the field. The bundler interface may provide such capabilities as ability to enter new backer's information and to update the information of existing cause participants who have again donated; ability to enter funds given directly to the bundler and associate those funds with the correct participant; methods to add additional prospective and present, but un-recorded; backers; ability to see the expenditure levels of individual or groups of participants and call up their names, ability to see fulfilled participation promises and the connected backer, ability to see names of participants who have provided peer-to-peer backer prospects, incentive contests among bundlers to drive recruitment excitement and competition, ability to compare donation response and totals of their charges to other bundlers and feedback on the total campaign goal status. A participant landing page and interface 120, which may include the desired personal information is to be entered, a donor variable set of suggested expenditure amounts, list of payment methods and form in which to make a donation, and an area for entry of peer to peer participant suggestions. The participant interface programming may also serve as a conduit for communication from the campaign and the participant, and may deliver immediate and subsequent messages of thanks, announcement or confirmation of expenditure related gifts announcements and schedules of upcoming events, possibly localized to the backer's area of residence and announcements of fundraising campaigns or cause related activities, for example writing one's politician or starting a local petition in support of the cause. There may also be interfaces for system administrator access to the system that would allow programming assistance to specialize the stock interface to specific campaign clients and to analyze and correct any issues found in operation of the system in general or with respect to a particular campaign client 125. Access to the service's system would most often be cloud based 130, possibly mediated by secure internet connection although the invention does not depend on any specific network technology. System administrative connections may also be local. Activities of a campaign may be controlled by the campaign control module which acts as a supervisor and coordinator for the system's other modules and functions 135. Among other tasks, this module accepts and translates campaign specific commands parameters and data entered by campaign directors, officers, bundlers and participants into formats usable by the system. Human entered information is also normalized by this module 135. Once the campaign is started, the campaign control module permanently stores all campaign defining commands, parameters and data; runtime actions such as what participants get requests, when and if the respond, how involved each participant becomes, campaign goal completion times, bundler efficacy in soliciting campaign interest pledges, pledge turnover, among other vital statistics known to those skilled in the art; in the campaign data store 140. If applicable, the campaign control module 135 may provide pre-designated search key-phrase and other needed parameters to the campaign backer web crawler 142 to allow it to find new participants as well as pre-entered specificity constraints to the campaign prospect backer evaluation module 150 to drive selection of a pool prospective backers that maximizes expenditure with minimal non-productive individual overhead. Prospective participants manually entered by campaign personnel such as officers and bundlers may also be sent to the backer prospect data store 145 for campaign prospect backer evaluation module 150 predictive analysis of expenditure potential. Lastly, the campaign control module 135 tracks the operation of the post-expenditure follow-up module 155 to ensure that the correct messages are automatically, or by campaign agent request, sent to the correct participants at the correct times to maximize participant enthusiasm for the cause and willingness to participate again when called upon; includes a third party solution integration module 165 to allow exchange of campaign related information between the invention and legacy solutions such as but not limited to BLACKBAUD RAISER'S EDGE™, BLACKBAUD'S LUMINATE™, and CAUSEVOX™, just to name a few examples known to those skilled in the art; and maintains the integrity of the backer data store 170 to insure that duplicate donor records are found and correctly merged for most up-to-date contact, income and contact preference information, if available, and that records are updated as new information is produced either due to web search 142 or campaign agent, such as backer 120, bundler 115, or campaign officer 110 provided information. The backer data store 170 is the campaign independent permanent participant storage mechanism for the subscribing organization. As illustrated, in the embodiment 100 the system is engineered with modules to carry out robust high speed web searches, the campaign backer web crawler 142, which may use multiple server hosted preprogrammed web spiders, which while autonomously configured are deployed within a web scraping framework (not shown) of which SCRAPY™ is an example, to identify and retrieve data of interest from web based sources that are not well tagged by conventional web crawling technology using both public and proprietary information sources such as social media sites, news and financial archives, census information, personal statistics look-up sites, county tax record databases, and other, similar sources known to those skilled in the art, to find prospective new participants, if called upon with temporary data storage 145 which may employ rapid responding databases such as, but not limited to MONGODB™, COUCHDB™, CASSANDRA™ or REDIS™ depending on the embodiment, a preliminary data filter, the campaign prospect backer evaluation module 150 which is engineered to normalize the data for system use, remove empty or damaged data packets and may eliminate data sets that do not contain desired identifiers or contain one or more contraindicated identifiers, and an intelligent, predictive analytics module, the backer analytics module 160 which runs powerful information theory based predictive statistics functions and machine learning algorithms to allow the donation actions of a candidate donor to be rapidly forecast based upon the current system derived results and then choosing each of a plurality of possible pre-programmed and learned parameters to select prospective donors most likely to donate monetary or in kind gifts to the campaign. The campaign backer web crawler 142 is also employed to retrieve campaign important personal data related to existing and enrolled new participants, such as but not limited to current address, other causes with which she participates, amounts expended, income, and financial worth, among other data as may be requested by the directing agents of the campaign which in conjunction with the backer analytics module 160, now analyzing available current backer data and trends, assists in personalizing participation requests to interest the participant as well as place the requested participation levels within a backer's projected range of support. These data being retrieved from both public and proprietary, subscribed sources such as but not limited to social media sites, census information, personal statistics look-up sites, county tax record databases and other, similar sources known to those skilled in the art. These data may be used to update participant's records in the backer data store 170 such that the most up-to-date donor information is presented on the respective user interfaces of campaign directors and officers 110, and campaign bundlers 115 and are also used to either automatically create or guide the manual creation of the most persuasive, personalized and positive participation oriented communication with each backer contacted during the campaign.

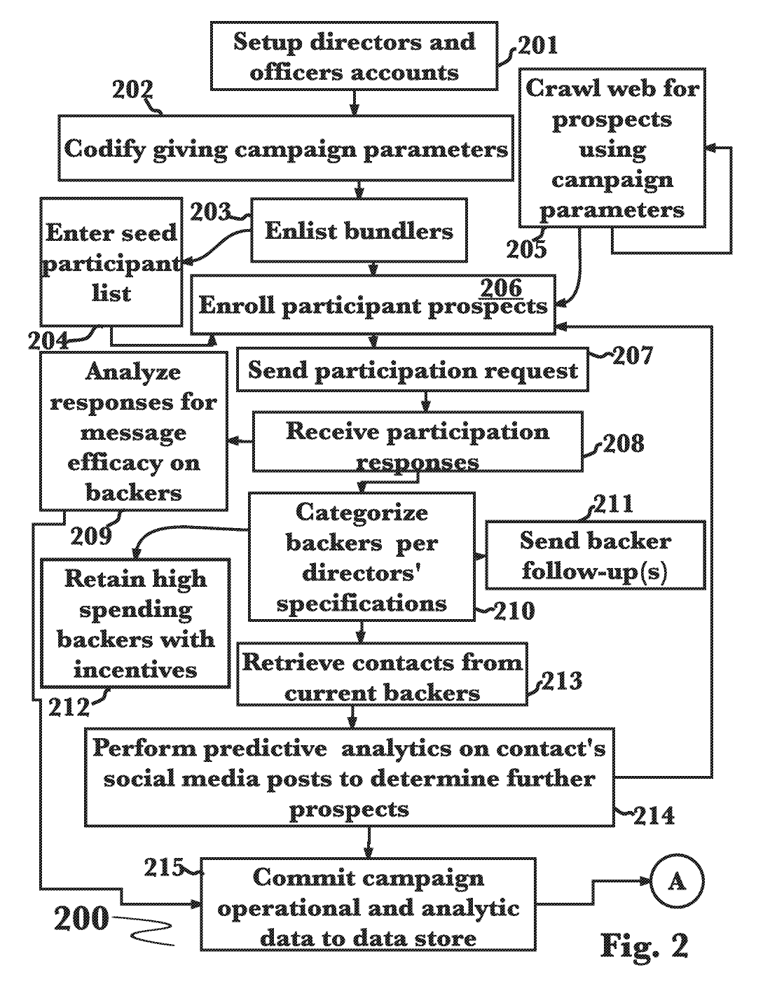

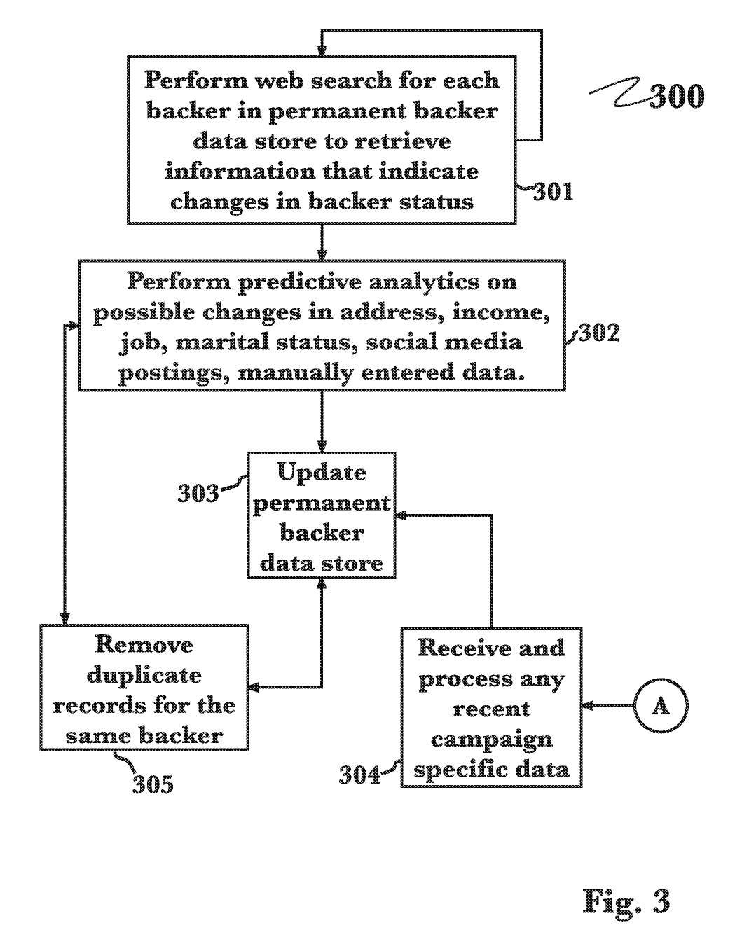

FIG. 2 is a flow diagram of exemplary function of the funding campaign and backer cultivation management system 200 according to an embodiment of the invention. Campaign management begins when the directors and officers are identified and accounts for them established on the management service system by a system administrator 201. One or more directing agents including the director and the officers will then enter the parameters which define the giving campaign 202. These parameters may include the specific beneficiary of campaign, the region selected in which to conduct the campaign, whether in-kind giving is allowed, what in-kind gifts may be accepted when audits may be required, to whom special gift, such as in-kind gift inquiries should be forwarded, the participant subgroup to use, if appropriate, whether backers will be enrolled through web search using likely key-phrases and identifiers on public forums such as social media, as well as many other parameters for the facets of campaign that are known to those skilled in the art. Once the scope of the campaign is codified, campaign bundlers may be enlisted and given bundler accounts on the management system with which to track their participants, participation solicitation efficiency and participation promise fulfillment progress among other bundler metrics information 203. Bundlers may arrive with their own campaign backer lists which may then be added to the campaign along with other backer identified by campaign agents out of channel 204. These participants may be manually entered into the system 204 with supporting identifying information along with web crawler 142 retrieved 205 and predictive analytics identified 160 backer prospects 206. Participation request messages, which may be specialized in appearance wording or participation amount request values are sent to the participant prospects 207. Participation promise responses, including, for fundraisers, donation use restrictions which are attach to the donation record to insure correct action and recurring donations in which case the end date is also recorded in the donation record for timely action, are received 208, usually automatically through credit card or debit card payment at a donor landing page, with credit card transactions handled automatically unless an issue arises and campaign agents must be alerted, and, if necessary may be entered into the system manually to assure the correct donation is associated with the correct donor. Current participant data may analyzed to determine such important interim factors as the efficiency of the currently used participation request messages on both the general backer population and individual backers for demographics and possible customization during the remaining campaign 209, among other factors known to those skilled in the art. These analysis data may be committed to the permanent campaign related data store for future analysis and planning 215. Participants may also be categorized based upon such factors as participation level, although other factors may be used 210, such that special letters of thanks, rebates and gifts might be sent based upon a pre-designed participation hierarchy to specifically maintain a positive relationship and contact with those backers in hopes of their continued active participation in future campaigns 212. All backers not qualifying for special giving categories may also be automatically sent messages of thanks that include such information as tax and other regulatory reporting information and token gifts, again to maintain positive relationships with them for future campaign participation 211. In certain cases, participants may be asked to provide the names and some identifying personal information, such as, but not limited to an email address, of others they know who they feel may have interest to participate in the campaign 213. This type of “peer to peer” backer networking has been found to be very effective in increasing participation success and processing and improving upon the utility of such peer to peer data is a major feature of the current service system 100. Analytics 160 may be run on the backer provided contact's social media posts to better align the participation request message with the predictive mindset and means of the prospective participant to, once again, maximize the chance that the prospect will respond and participate at the predicted level 214. Lastly, all campaign specific information is permanently stored 215. Participant specific information may be forwarded to a campaign independent data store maintained for the campaign author 215 (see FIG. 3).

FIG. 3 is a flow diagram of exemplary function of the campaign and participant cultivation management system to ensure the integrity of the permanent backer database 300 according to an embodiment of the invention. Reliable information, including contact information about backers is an extremely important resource for organizations requiring popular participation. The system includes several resources to automatically assist in keeping participant information records current and the data in them reliable. Web searches 301 are performed by the system using the campaign backer web crawler 142 at predetermined intervals to retrieve the most current information about each participant using both publically available sources such as social media posts, among others, and private, possibly subscription based, services such as address tracking repositories and personal information lookup sources among other resources familiar to those skilled in the art. Some of this information, including whether an address change has occurred, may not be reliable, data from different sources conflict, social media posts may be incorrect or reflect short lived, transient, opinions or conditions. The system therefore makes use of its predictive analytics functions 160 to automatically arrive at a reliable answer 302. Entries manually made by directors, officers, bundlers and participants may also be imperfect, misspellings within contact information and entry of information meant for one backer into the record of another backer, among other clerical errors, may occur. The system, therefore, may analyze these manual entries to confirm correctness 302. Failure to arrive at a pre-defined level of reliability for a certain piece of critical participant information such as main contact channel address may result in the record being flagged or the system attempting to directly confirm the data through donor contact prior to updating the permanent donor data store 303. Duplicate records for the same donor may also serve to reduce information reliability and therefore the system scans to database for such duplicates and may use predictive analytics 302 to assure that potential duplicates are reliably removed from the database 303 without removal of highly similar records pointing to two separate backers 305. One period of time where reliable and timely update of the permanent backer data store is critical is during and after a funding campaign where new participants may be added and data about existing participants may be reported and changed. The system is designed to automatically update the permanent database with this information (304, and see FIG. 2)

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

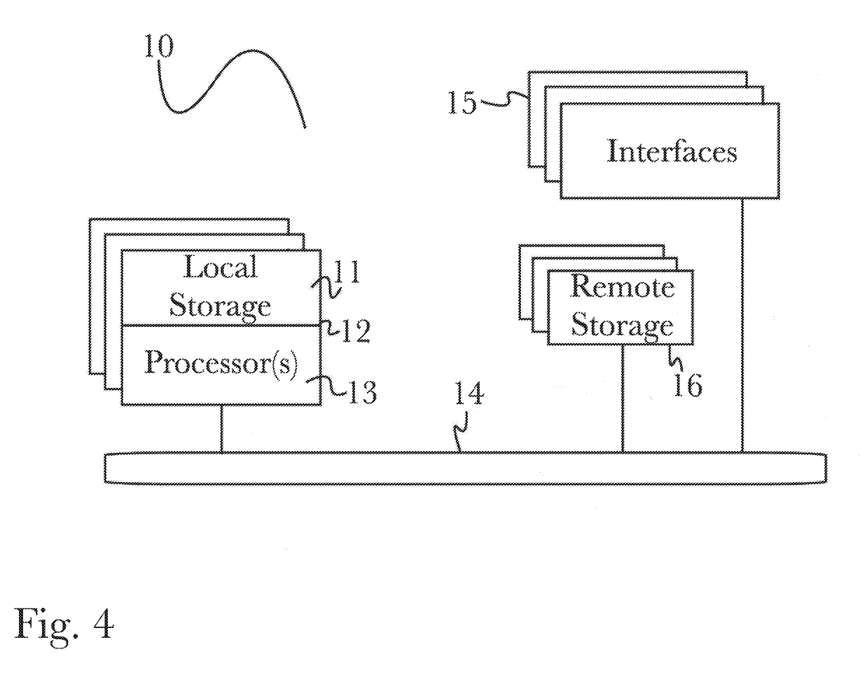

Referring now to FIG. 4, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown and described above illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

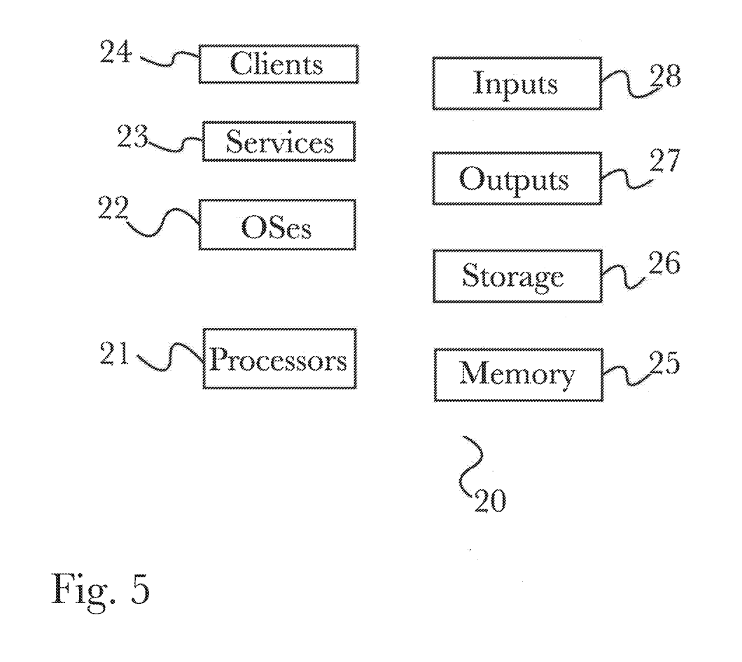

In some embodiments, systems according to the present invention may be implemented on a standalone computing system. Referring now to FIG. 5, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above). Examples of storage devices 26 include flash memory, magnetic hard drive, CD-ROM, and/or the like.

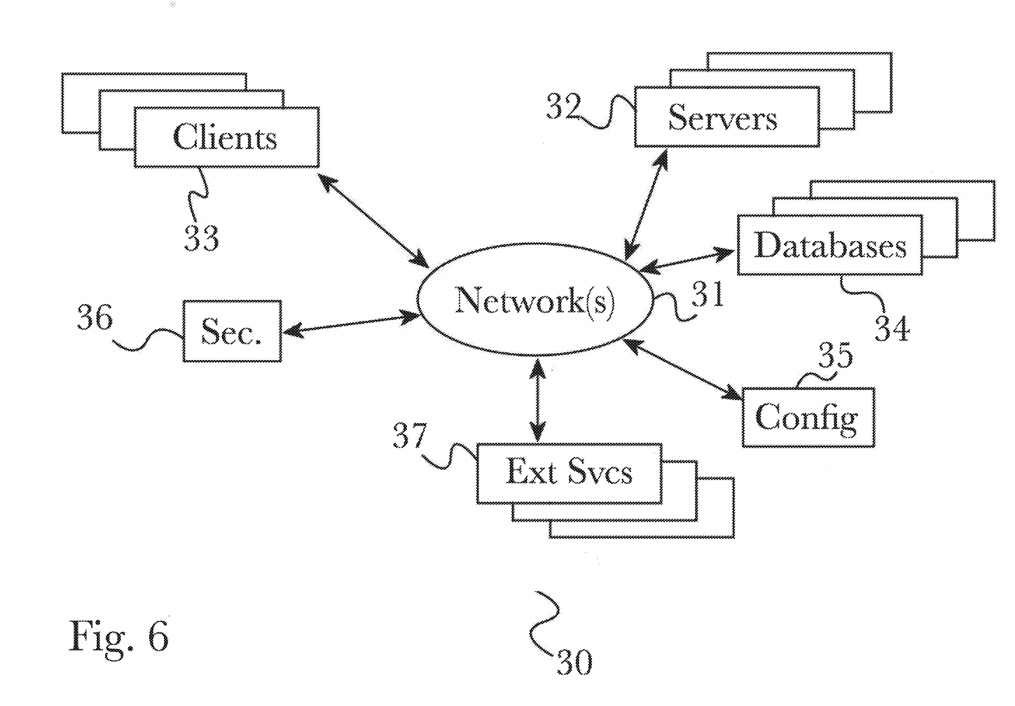

In some embodiments, systems of the present invention may be implemented on a distributed computing network, such as one having any number of clients and/or servers. Referring now to FIG. 6, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated above. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

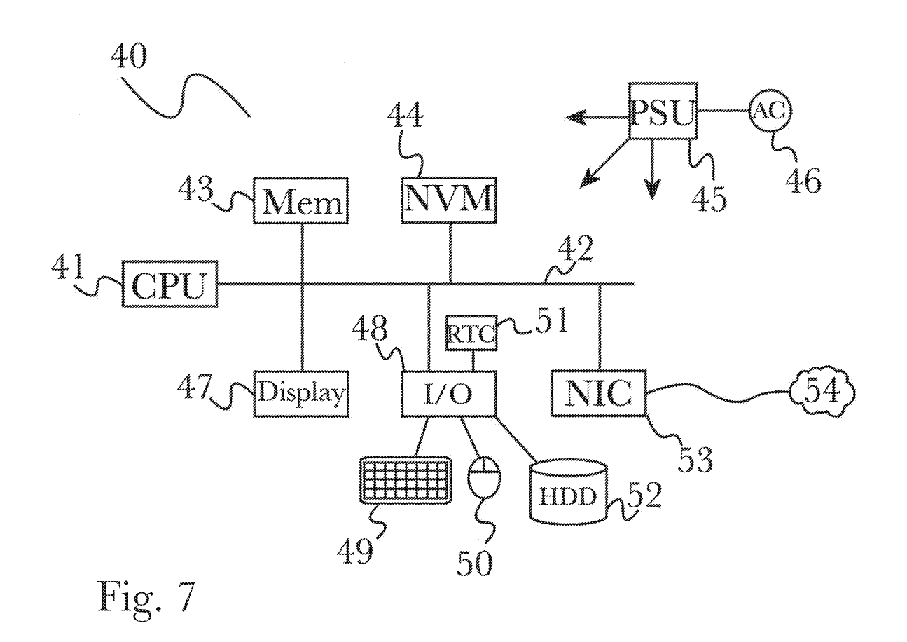

FIG. 7 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client.

The skilled person will be aware of a range of possible modifications of the various embodiments described above. Accordingly, the present invention is defined by the claims and their equivalents.

What is claimed is:

1. A system for prospective participant action anticipation employing a predictive analytics intelligence platform comprising:
a campaign control module stored in a memory of and operating on a processor of a computing device and configured to:
employ commands, parameters, and data completely defining a campaign from a campaign agent with campaign definition authority;
use the campaign defining commands, parameters and data to control and coordinate the actions of other system modules to carry out their functions in the campaign;
use campaign defining commands, parameters and data to group participants based upon pre-defined participation characteristics to enhance participant goodwill, interest and expenditure towards both during and after the campaign;
maintain progress data on pre-determined facets of the campaign; and
direct maintenance of donor record data store record integrity;
a web search module stored in a memory of and operating on a processor of a computing device and configured to:
retrieve plurality of contact information specific to campaign participants from a plurality of cloud sources both public and proprietary;
retrieve social media posts specific to campaign cause from a plurality of cloud sources both public and proprietary; and
retrieve participant life status information useful to personalizing the campaign message from a plurality of cloud sources both public and proprietary;
a predictive analytics module stored in a memory of and operating on a processor of a computing device and configured to:
use social media posts retrieved by the web search module to predict the likelihood of the participant to participate and the level of connection the donor has to a fundraising cause;
use financial and life status data retrieved by the web search module to predict a monetary range likely to elicit a maximal participation level choice by the participant; and
use social media posts and contact information to predict the reliability of newly discovered contact address changes as part of function to maintain participant record data store record integrity; and
a user interface stored in a memory of and operating on a processor of a computing device and configured to:
accept commands, parameters and data from commands, parameters, and data completely defining a fundraising campaign from a campaign agent with campaign definition authority;
accept donor information participation pledge information and participation level information from a campaign bundler;
display goal information, pledged participation level information and participation levels already achieved in formats most useful to campaign agents and predesignated by campaign agents with campaign definition authority; and
receive peer-to-peer participant contact information from participants already enrolled in the campaign.

2. A method for prospective participant action anticipation employing a predictive analytics intelligence platform comprising the steps of:
a) receiving a campaign plan from a campaign agent with campaign definition authority into a central control module using a user interface;
b) implementing and coordinating the campaign plan throughout the system using the central control module;
c) retrieving participant contact information, income and lifestyle data and social media postings from both private and proprietary sources using a web search module;
d) determining reliable contact information, predictive level of interest in campaign cause, predictive participation level range or in-kind donation possibility using a predictive analytics module;
e) predicting the best participation evoking message for a participant using the predictive analysis module;
f) implementing a participant interest, goodwill and participation retention program using both the predictive analytics module and the central control module;
g) maintaining integrity of a participant record data store using the web search module, the predictive analytics module and the central control module;
h) displaying campaign progress in multiple predesignated formats using the user interface;
i) receiving peer to peer participant information from enrolled participants using the user interface.
